(19) United States
(12) Patent Application Publication
(10) Pub. No.: US 2026/0250202 A1
(43) Pub. Date: Aug. 27, 2026

(54) METHOD OF MANUFACTURING CERAMIC MATRIX COMPOSITES REINFORCED WITH METALLIC PARTICLES

(71) Applicant: POLITECHNIKA WARSZAWSKA, Warszawa (PL)

(72) Inventors: Joanna Tanska, Olsztyn (PL); Paulina Wiecinsak, Warszawa (PL); Jakub Misiukiewicz, Krynki (PL); Anna Wieclaw-Midor, Warszawa (PL); Pawel Falkowski, Marki (PL)

(21) Appl. No.: 18/875,936

(22) PCT Filed: Jul. 7, 2023
(86) PCT No.: PCT/PL2023/050052

§ 371 Date: Dec. 17, 2024

(30) Foreign Application Priority Data
Jul. 7, 2022 (PL) P.441671

(51) Int. Cl. C04B 35/117; B22F 10/12; B22F 10/64; B33Y 10/00; B33Y 40/20; C04B 35/14; C04B 35/488; C04B 35/626; C04B 35/634; C04B 35/64

(52) U.S. Cl. CPC C04B 35/117; B22F 10/12; B22F 10/64; B33Y 10/00; B33Y 40/20; C04B 35/14; C04B 35/488; C04B 35/6261; C04B 35/6264; C04B 35/6269; C04B 35/63424; C04B 35/6346; C04B 35/64; B22F 2301/15; B22F 2301/20; B22F 2302/25; B22F 2302/253; B22F 2302/256; B22F 2998/10; C04B 2235/3217; C04B 2235/3244; C04B 2235/3418; C04B 2235/404; C04B 2235/405; C04B 2235/5436; C04B 2235/5445; C04B 2235/6026; C04B 2235/656; C04B 2235/6582

(57) ABSTRACT

A method for manufacturing articles comprised of ceramic matrix composites reinforced with metallic particles, comprises a) producing a mixture by mixing a solvent in with two organic monomers, and with a photoinitiator, wherein the photoinitiator includes at least one of ethyl (2,4,6-trimethylbenzoyl)phenylphosphinate and bis-(2,4,6-trimethylbenzoyl)phenylphosphine oxide; b) producing a further mixture by adding and mixing with the mixture produced in (a) a dispersing agent, a ceramic powder, and a metal powder, wherein the dispersing agent includes at least one of a polyester and polyamine copolymer as a 50% solution in a trichlorethylene-ethanol azeotrope, and a polyester and polyamine copolymer as a 50% solution in 2-butanone; c) mixing and deaerating the further mixture produced in (b); d) forming the deaerated mixture produced in (c) using a 3D stereolithographic printer to produce a product item in accordance with a previously prepared product item design; e) sintering the product item produced in (d).

### TECHNICAL FIELD

Exemplary arrangements relate to a method for manufacturing ceramic matrix composites reinforced with metallic particles by stereolithography method (SLA), which belongs to 3D printing techniques.

### BACKGROUND

A limitation of ceramic materials is their brittleness. To attempt to address this problem, metallic particles may be introduced into the ceramic matrix to form a ceramic-metal composite. The main advantage of composites over single-phase ceramics is their higher fracture toughness, and the increase in this toughness depends on the type, quantity, size and shape of the metal particles used. The metallic phase can additionally affect the physical, mechanical and thermal properties of composite materials [M. Chmielewski, J. Dutkiewicz, D. Kalinski, L. Litynska-Dobrzynska, K. Pietrzak, A. Strojny-Nedza, “Microstructure and properties of hot-pressed molybdenum-alumina composites,” Archives of Metallurgy and Materials, 57, (3), pp. 686-693, 2015].

Ceramic matrix composites reinforced with metallic particles will be referred to hereinafter as ceramic-metal composites. It should be noted, however, that in the scientific literature on the subject, metal matrix composites, reinforced with a ceramic phase in the form of particles or fibers, may also be called ceramic-metal or metal-ceramic composites. Ceramic matrix composites reinforced with metal particles, thanks to their properties, find numerous applications in various industries, e.g. in construction, transport and electronics, as anti-corrosion and thermal coatings and orthopedic implants [K. Konopka, Particle-Reinforced Ceramic Matrix Composites—Selected Examples,” Journal of Composites Science, 6, (6), 2022].

There are several methods of obtaining ceramic-metal composites. One of them is the formation of ceramic-metal composites from powders. The first stage of this method is the preparation of appropriate granulates by mixing a ceramic powder with metal powders or their oxides. Then, the additive that improves the compression (binder) is added. The powder mixture is placed in a mold and compressed axially or isostatically to produce a green body. The last stage is sintering of the green bodies. This method is popular due to the simplicity of the process, but its main limitation is the great difficulty in forming products of a complex shape and large dimensions [J. Zygmuntowicz, P. Falkowski, A. Miazga, K. Konopka, “Fabrication and characterization of ZrO₂/Ni composites,” Journal of the Australian Ceramic Society, 54, (4), pp. 655-662, 2018]. In addition, the use of high pressures are required and the commonly used metal dies wear out quickly.

Ceramic-metal composites can also be obtained by methods using slurries. An example of such a method is slip casting, in which a suspension of ceramic particles and metal particles in a solvent with the addition of a dispersing agent is poured into porous molds-most often made of gypsum [M. Gizowska, K. Konopka, M. Szafran, “Properties of water-based slurries for fabrication of ceramic-metal composites by slip casting method”, Archives of Metallurgy and Materials, 56, (4), pp. 1105-1110, 2011]. The solvent diffuses through the pores of the mold due to the action of capillary forces. After drying, the products are removed from the mold and subjected to the sintering process. The advantages of the slip casting method include the fact that it does not require use of specialized equipment, while the drawbacks are: the need to use casting molds, long duration of the process, and non-uniform densification of the product.

Among the methods of forming ceramic materials, additive manufacturing (AM) methods are gaining increasing interest, as they make it possible to manufacture precise and complex elements without the use of casting molds. Additive methods can be successfully used both in serial production and to obtain single, unique elements. Unlike conventional molding methods (such as injection molding, slip casting, gelcasting), the AM methods do not require the production of expensive molds. The printing process is preceded only by creating a three-dimensional model in a CAD (computer aided design) software program, which significantly reduces the cost of producing a single element.

The most common 3D printing method is stereolithography. It includes subjecting a ceramic dispersion containing photocurable resins to selective hardening of the surface, layer by layer, with the use of a light source in the ultraviolet range [F. Doreau, C. Chaput, T. Chartier, “Stereolithography for Manufacturing Ceramic Parts,” Advanced Engineering Materials, 2, (8), pp. 493-496, 2000]. The individual layer curing mechanism is radical photopolymerization. Such a reaction can occur at the room temperature at a high rate, but it is prone to so-called oxygen inhibition.

Photocurable suspensions, the composition of which mainly includes: a ceramic powder, a solvent, a monomer or a mixture of organic monomers, a dispersing agent and a photoinitiator, are of fundamental importance in the stereolithographic printing process and must meet a number of requirements in order to successfully be employed in it. The ceramic particles must be homogeneous and evenly dispersed in the photopolymerization medium and must not sediment for a sufficiently long period, because the printing process may last from several hours to even several days in the case of large-size products. Unstable suspensions can lead to material inhomogeneity in the fabricated parts and, consequently, to anisotropy of the finished product [M. L. Griffith, J. W. Halloran, “Freeform fabrication of ceramics via stereolithography,” Journal of the American Ceramic Society, 79, (10), pp. 2601-2608, 1996].

In the case of ceramic suspensions, their rheological properties, including viscosity and yield stress, also play a key role, which is why it is important to optimize the composition of the photocurable dispersion. On the one hand, a higher volume fraction of ceramic powder promotes lower shrinkage and higher density after sintering, and thus higher mechanical strength, while a lower powder proportion reduces viscosity of the suspension. In addition, a higher proportion of ceramic powder in the suspension reduces its cure depth, i.e. the depth to which ultraviolet radiation penetrates while providing enough energy to initiate the polymerization reaction.

Radiation penetration is related to the phenomenon of light scattering by ceramic particles. Light scattering occurs when two media have different refractive indexes, RI, and differences in their values allow the scattering of a light beam to be quantified. Depending on the value of the refractive index, ceramic powders scatter UV radiation in different ways. The higher this value, the more light is scattered, resulting in a reduction in the depth of polymerization. The intensity of this phenomenon depends not only on the type of the powder and its amount, but also on the particle size. Ceramic powders of smaller sizes have a larger specific surface area, therefore, stronger scattering is observed for them [Z. Chen, Z. Li, J. Li, C. Liu, C. Lao, Y. Fu, C. Liu, Y. Li, P. Wang, Y. He, “3D printing of ceramics: A review,” Journal of the European Ceramic Society, 39, (4), pp. 661-687, 2019].

In addition, a mismatch of the refractive index of the suspension and the intensity of the light used for its curing may result in a reduction in the depth of polymerization, and thus cause formation of a structure with cracks, lower mechanical strength and surface roughness. Moreover, the prepared dispersion must be homogeneous to maintain the continuity of the ceramic phase in the polymerized product. Lack of homogeneity could result in crack formation during sintering [S. A. Rasaki, D. Xiong, S. Xiong, F. Su, M. Idrees, Z. Chen, “Photopolymerization-based additive manufacturing of ceramics: A systematic review,” Journal of Advanced Ceramics, 10, (3), pp. 442-471, 2021].

The publication by Bhargavi Mummaredda, et al., “The fracture properties of metal-ceramic composites manufactured via stereolithography,” International Journal of Applied Ceramic Technology, 2020; 17:413-423 discloses a method for manufacturing metal-ceramic composites in a two-step process. First, the so-called ceramic preform, specifically made of a SiO₂-containing polymer resin, was obtained via stereolithography, followed by a curing and sintering phase. Then, these specimens were subjected to metal infiltration to obtain metal-ceramic composites.

Existing methods of manufacturing articles comprised of ceramic matrix composites reinforced with metallic particles may benefit from improvements.

### SUMMARY

Exemplary arrangements provide a method for manufacturing articles comprised of ceramic-metal composites with a complex shape, high density and good mechanical properties, in a single-step forming process, from a dispersion containing both ceramic and metallic particles and without the need of employing casting molds.

Exemplary arrangements provide a method for manufacturing articles comprised of ceramic matrix composites reinforced with metallic particles, that comprises the following steps. In a step (a) a solvent in an amount of 2-15 parts by weight is mixed with two organic monomers in an amount of 2-15 parts by weight each, and with a photoinitiator in an amount of 1-5 parts by weight based on the sum of the weights of organic monomers. The photoinitiator is selected from a group of materials comprising: a mixture of ethyl (2,4,6-trimethylbenzoyl)phenylphosphinate and bis-(2,4,6-trimethylbenzoyl)phenylphosphine oxide; bis-(2,4,6-trimethylbenzoyl)phenylphosphine oxide; and ethyl (2,4,6-trimethylbenzoyl)phenylphosphinate. In a step (b) then a dispersing agent in an amount of 0.2-5.0 parts by weight, a ceramic powder in an amount of 65-90 parts by weight, and a metal powder in an amount of 0.1-10.0 parts by weight are added to the mixture of step (a) and mixed again. The dispersing agent is selected from a group of materials comprising: a polyester and polyamine copolymer as a 50% solution in a trichloroethylene-ethanol azeotrope; and a polyester and polyamine copolymer as a 50% solution in 2-butanone. In a step (c) the resulting dispersion produced in step (b) is mixed and deaerated. In a step (d) product items are formed from the material resulting from step (c) using a 3D stereolithographic printer in accordance with a previously prepared product design. In a step (e) the resulting products items formed in step (d) are sintered to produce the articles that result from the method.

In some exemplary arrangements, the step (c) is carried out twice.

In some exemplary arrangements in step (a), 2-ethylhexanol is used as the solvent.

In some exemplary arrangements in step (a) as organic monomers, triethylene glycol dimethacrylate and poly(1,3-propylene glycol) dimethacrylate are used.

In some exemplary arrangements in step (b), the ceramic powder is selected from the group comprising: Al₂O₃, ZrO₂ and SiO₂.

In some exemplary arrangements in step (b) in which the ceramic powder comprises Al₂O₃, the Al₂O₃ has a particle size in the range of 150 nm-2 μm.

In some exemplary arrangements in step (b) in which the ceramic powder comprises ZrO₂, the ZrO₂ has a particle size in the range of 40 nm-2 μm.

In some exemplary arrangements in step (b) in which the ceramic powder comprises SiO₂ the SiO₂ has a particle size in the range of 100 nm-1.5 μm.

In some exemplary arrangements in step (b) the metal powder is selected from the group comprising: nickel and molybdenum.

In some exemplary arrangements in step (b) the metal powder has a particle size in the range of 3-15 μm.

In some exemplary arrangements in step (b), the mixing is carried out in a planetary ball mill at a rotational speed of from 200 rpm to 400 rpm for from 30 to 120 minutes.

In some exemplary arrangements in step (c) deaeration is carried out in a high-speed homogenizer with a rotational speed of from 500 rpm to 2200 rpm for from 1 to 15 minutes.

In some exemplary arrangements in step (d) the printing step is carried out with the following parameters: a single layer height in the range of 0.01 mm-0.05 mm, a base printing time in the range of 10 s-60 s, an attaching time in the range of 10 s-60 s, a light intensity in the range of 50%-100%.

In some exemplary arrangements in step (e) the sintering is carried out at a temperature of 1350°° C.-1650° C. in an argon-hydrogen reducing atmosphere for 1-5 h.

As shown in the following exemplary working examples, the use of the method of 3D stereolithographic printing in the method according to the exemplary arrangements make it possible to obtain articles comprised of ceramic-metal composites with an even distribution of metallic grains in the ceramic matrix, which can be seen in the images from a scanning electron microscope with the EDS detector (e.g. FIG. 1.).

The suspensions of the method used for forming the items in step (d) in the working examples were characterized by suitably low viscosity and yield point. Moreover, they were rheologically stable and no sedimentation was observed for them. After irradiation with a UV lamp, the product items formed from the dispersions have been photopolymerized, and the cure depths obtained for them were appropriate for the stereolithographic printing method.

The obtained printouts of the product items in step (d) in the working examples made a good representation of the previously prepared design, both in terms of the shape and size. After sintering in step (e), the articles provided were characterized by a very good degree of compaction (nearly 100% of the theoretical density during pressureless sintering), which had a positive effect on their mechanical properties.

### BRIEF DESCRIPTION OF DRAWINGS

The articles produced in accordance with the exemplary methods have been illustrated in the drawings, wherein:

FIG. 1A shows an image at a first magnification from a scanning electron microscope (SEM) of an Al₂O₃—Ni composite obtained via stereolithographic 3D printing and pressureless sintering.

FIG. 1B shows an image corresponding to FIG. 1A at a different magnification.

FIG. 1C shows an X-ray energy dispersive spectroscopy (EDS) image confirming the presence of alumina and nickel in the composite.

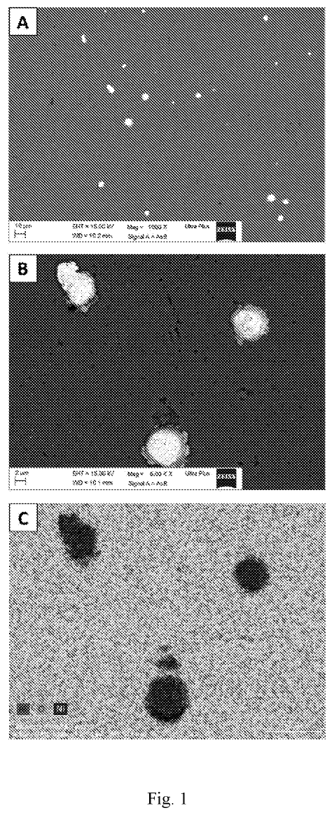

### DETAILED DESCRIPTION

The subject-matter of the exemplary methods has been presented in detail in the following working Examples 1 and 2.

### Example 1

The ceramic dispersion was prepared, in which a ceramic powder used was alumina, Al₂O₃, under the name of TM-DAR™ (Taimei Chemicals, Japan) with a density of 3.98 g/cm³ and an average particle size of 150 nm, in the amount of 35.82 g (which was 45% by volume of the solid phase, equivalent to 77.18 parts by wt). The metallic phase was introduced in the form of a nickel, Ni, powder (available from Createc, Poland) with a density of 8.71 g/cm³ and an average particle size of 9.3 μm, in the amount of 0.8711 g. Two monomers were used: triethylene glycol dimethacrylate in the amount of 3.53 g and poly(1,3-propylene glycol) dimethacrylate in the amount of 3.53 g. In the role of the solvent, 2-ethylhexanol was used in the amount of 3.53 g, and the dispersing agent was a copolymer of polyester and polyamine under the trade name of KD1™ in the form of a 50% solution in the trichloroethylene-ethanol azeotropic mixture, in the amount of 1.07 g. As the photoinitiator, 0.21 g of a compound under the trade name of Omnirad 2100™, which is a mixture of ethyl (2,4,6-trimethylbenzoyl)phenylphosphinate and bis-(2,4,6-trimethylbenzoyl)phenylphosphine oxide, was used.

The mixture of the monomers, solvent and photoinitiator was mixed for 15 minutes in the Retsch PM200™ planetary ball mill at 300 rpm. Then the dispersing agent, ceramic powder and metallic powder were added. The dispersion was mixed for half an hour in the mill at 300 rpm, then the mixing speed was increased to 350 rpm and mixing was continued for further 15 minutes. Then, the suspension was placed in the Thinky ARE-250™ high-speed homogenizer, which was used to simultaneously both mix and deaerate the suspensions. The dispersions were mixed for 2 minutes at 800 rpm and then degassed (deaerated) for 2 minutes at 1800 rpm to remove air bubbles. The described cycle was carried out twice.

In the next step, product items in the shape of a cylinder were obtained by stereolithographic printing using the FlashForge Hunter™ printer, which was preceded by the preparation of the design of the product item with the Autodesk Fusion 360™ graphics software and the selection of printing parameters. The height of a single layer was 0.02 mm, the base printing time-20 s, the attaching time-30 s, the number of layers-250, the light intensity 65%.

The sample product items samples were then sintered at 1550° C. (heating rate at 5° C./min to 1550° C., holding at 1550° C. for 1 hour, cooling down to the room temperature at 5° C./min) in an argon-hydrogen reducing atmosphere resulting in the articles.

The dispersion from which the product item specimens were formed and obtained was characterized by a viscosity of about 11 Pa's at a shear rate of 1s⁻¹; about 0.8 Pa's at a shear rate of 50 s⁻¹ and a yield point of about 9.0 Pa, and the printing produced a cure depth of 0.15 mm.

The resulting parameters allowed to obtain unsintered green bodies by means of stereolithographic printing.

Homogeneous product item samples were obtained, which in the green state were characterized by a relative density of 63.8%. No defects were observed on the surface of the samples. The samples resulting in the articles after sintering were characterized by a relative density of 98.7%. The analysis of the microstructure of the articles showed that the Al₂O₃ matrix is well densified, and the nickel grains are evenly distributed in the matrix.

### Example 2

The ceramic dispersion was prepared, in which the ceramic powder used was alumina, Al₂O₃, under the name of TM-DAR™ (Taimei Chemicals, Japan) with a density of 3.98 g/cm³ and an average particle size of 150 nm, in the amount of 35.82 g (which was 45% by volume the solid phase, equivalent to 77.18 parts by wt). The metallic phase was introduced in the form of a molybdenum, Mo, powder (available from Createc, Poland) with a density of 9.81 g/cm³ and an average particle size of 13.4 μm, in the amount of 0.9814 g. Two monomers were used: triethylene glycol dimethacrylate in the amount of 3.53 g and poly(1,3-propylene glycol) dimethacrylate in the amount of 3.53 g. In the role of the solvent, 2-ethylhexanol was used in the amount of 3.53 g, and the dispersing agent was a copolymer of polyester and polyamine under the trade name of KD1™ in the form of a 50% solution in the trichloroethylene-ethanol azeotropic mixture, in the amount of 1.07 g. As the photoinitiator, 0.21 g of a compound under the trade name of Omnirad 2100™, which is a mixture of ethyl (2,4,6-trimethylbenzoyl)phenylphosphinate and bis-(2,4,6-trimethylbenzoyl)phenylphosphine oxide, was used.

The mixture of the monomers, solvent and photoinitiator was mixed for 15 minutes in the Retsch PM200™ planetary ball mill at 300 rpm. Then the dispersing agent, ceramic powder and metallic powder were added. The dispersion was mixed for half an hour in the mill at 300 rpm, then the mixing speed was increased to 350 rpm and mixing was continued for a further 15 minutes. Then, the suspension was placed in the Thinky ARE-250™ high-speed homogenizer, which was used to simultaneously both mix and deaerate the suspensions. The dispersions were mixed for 2 minutes at 800 rpm and then degassed for 2 minutes at 1800 rpm to remove air bubbles. The described cycle of mixing and then degassing (deaerating) was carried out twice. In the next step, product items in the shape of a cylinder were obtained by stereolithographic printing using the FlashForge Hunter™ printer, which was preceded by the preparation of the product design with the Autodesk Fusion 360™ graphics software and the selection of printing parameters. The height of a single layer was 0.02 mm, the base printing time—20 s, the attaching time—30 s, the number of layers—250, the curing light intensity—65%. The specimens of the product items were then sintered at 1550° C. (heating rate at 5° C./min to 1550° C., holding at 1550°° C. for 1 hour, cooling down to the room temperature at 5° C./min) in an argon-hydrogen reducing atmosphere to produce the specimen articles.

The dispersion from which the product item specimens were obtained was characterized by a viscosity of about 11 Pa's at a shear rate of 1s⁻¹; about 0.8 Pa's at a shear rate of 50 s⁻¹ and a yield point of about 9.5 Pa, and the stereolithographic graphic printing produced a cure depth of 0.17 mm. The resulting parameters allowed to obtain the green product item specimens by means of stereolithographic printing.

Homogeneous product samples were obtained, which in the green state were characterized by a relative density of 61.2%. No defects were observed on the surface of the samples. The article samples after sintering were characterized by a relative density of 99.6%. The analysis of the microstructure of the article samples showed that the Al₂O₃ matrix is well densified, and the molybdenum grains are evenly distributed in the matrix.

### Comparative Example 1

The ceramic dispersion was prepared, in which the ceramic powder used was alumina, Al₂O₃, under the name of TM-DAR™ (Taimei Chemicals, Japan) with a density of 3.98 g/cm³ and an average particle size of 150 nm, in the amount of 35.82 g (which was 45% by volume the solid phase, equivalent to 77.18 parts by wt). The metallic phase was introduced in the form of a molybdenum, Mo, powder (available from Createc, Poland) with a density of 9.81 g/cm³ and an average particle size of 13.4 μm, in the amount of 0.9814 g. Two monomers were used: triethylene glycol dimethacrylate in the amount of 3.53 g and poly(1,3-propylene glycol) dimethacrylate in the amount of 3.53 g. In the role of the solvent, 2-ethylhexanol was used in the amount of 3.53 g, and the dispersing agent was a copolymer of polyester and polyamine under the trade name of KD1™ in the form of a 50% solution in the trichloroethylene-ethanol azeotropic mixture, in the amount of 1.07 g. As the photoinitiator, 0.21 g of 2-hydroxy-4′-(2-hydroxyethoxy)-2-methylpropiophenone under the trade name of Irgacure 2959™ was used.

The mixture of the monomers, solvent and photoinitiator was mixed for 15 minutes in the Retsch PM200™ planetary ball mill at 300 rpm. Then the dispersing agent, ceramic powder and metallic powder were added. The dispersion was mixed for half an hour in the mill at 300 rpm, then the mixing speed was increased to 350 rpm and mixing was continued for further 15 minutes. Then, the suspension was placed in the Thinky ARE-250™ high-speed homogenizer, which was used to simultaneously both mix and deaerate the suspensions. The dispersions were mixed for 2 minutes at 800 rpm and then degassed for 2 minutes at 1800 rpm to remove air bubbles. The described mixing and degassing cycle was carried out twice.

In the next step, an attempt was made to obtain sample item products in the shape of a cylinder by means of stereolithographic printing using the FlashForge Hunter™ printer, which was preceded by the preparation of the design with the Autodesk Fusion 360™ graphics software. After irradiating the first layer of the dispersion, it was observed that it did not harden, which prevented further 3D printing.

### Comparative Example 2

The ceramic dispersion was prepared, in which the ceramic powder used was alumina, Al₂O₃, under the name of TM-DAR™ (Taimei Chemicals, Japan) with a density of 3.98 g/cm₃ and an average particle size of 150 nm, in the amount of 35.82 g (which was 45% by volume the solid phase, equivalent to 77.18 parts by wt). The metallic phase was introduced in the form of nickel, Ni, powder (available from Createc, Poland) with a density of 8.71 g/cm³ and an average particle size of 9.3 μm, in the amount of 0.8711 g. Two monomers were used: triethylene glycol dimethacrylate in the amount of 3.53 g and dimethacrylate poly (1,3-propylene glycol) in the amount of 3.53 g. In the role of the solvent, 2-ethylhexanol was used in the amount of 3.53 g, and the dispersing agent was diammonium hydrogen citrate in the amount of 0.1075 g. As the photoinitiator, 0.21 g of a compound under the trade name of Omnirad 2100™, which is a mixture of ethyl (2,4,6-trimethylbenzoyl)phenylphosphinate and bis-(2,4,6-trimethylbenzoyl)phenylphosphine oxide, was used.

The mixture of the monomers, solvent and photoinitiator was mixed for 15 minutes in the Retsch PM200™ planetary ball mill at 300 rpm. Then the dispersing agent, ceramic powder and metallic powder were added. The bulk was mixed for half an hour in the mill at 300 rpm, then the mixing speed was increased to 350 rpm and mixing was continued for a further 15 minutes. Then, the suspension was placed in the Thinky ARE-250™ high-speed homogenizer, which was used to simultaneously both mix and deaerate the suspensions. The bulk was mixed for 2 minutes at 800 rpm and then degassed for 2 minutes at 1800 rpm to remove air bubbles. The described mixing and degassing cycle was carried out twice.

In the next step, an attempt was made to obtain products in the shape of a cylinder by means of stereolithographic printing using the FlashForge Hunter™ printer, which was preceded by the preparation of the design with the Autodesk Fusion 360™ graphics software. The suspension was characterized by too high viscosity (it had pasty consistency), preventing even filling the gap between the bottom of the cuvette and the platform on which subsequent layers of the product were formed. This prevented obtaining composite materials using the stereolithographic printing method.

### Comparative Example 3

The ceramic dispersion was prepared, in which the ceramic powder used was alumina, Al₂O₃, under the name of TM-DAR™ (Taimei Chemicals, Japan) with a density of 3.98 g/cm³ and an average particle size of 150 nm, in the amount of 35.82 g (which was 45% by volume the solid phase, equivalent to 77.18 parts by wt). The metallic phase was introduced in the form of a molybdenum, Mo, powder (available from Createc, Poland) with a density of 9.81 g/cm³ and an average particle size of 13.4 μm, in the amount of 0.9814 g. Two monomers were used: triethylene glycol dimethacrylate in the amount of 3,53 g and poly(1,3-propylene glycol) dimethacrylate in the amount of 3.53 g. In the role of the solvent, 2-ethylhexanol was used in the amount of 3.53 g, and the dispersing agent was a copolymer of polyester and polyamine under the trade name of KD1™ in the form of a powder. As the photoinitiator, 0.21 g of a compound under the trade name of Omnirad 2100™, which is a mixture of ethyl (2,4,6-trimethylbenzoyl)phenylphosphinate and bis-(2,4,6-trimethylbenzoyl)phenylphosphine oxide, was used.

The mixture of the monomers, solvent and photoinitiator was mixed for 15 minutes in the Retsch PM200™ planetary ball mill at 300 rpm. Then the dispersing agent, ceramic powder and metallic powder were added. The dispersion was mixed for half an hour in the mill at 300 rpm, then the mixing speed was increased to 350 rpm and mixing was continued for a further 15 minutes. Then, the suspension was placed in the Thinky ARE-250™ high-speed homogenizer, which was used to simultaneously both mix and deaerate the suspensions. The dispersion was mixed for 2 minutes at 800 rpm and then degassed for 2 minutes at 1800 rpm to remove air bubbles. The described mixing and degassing cycle was carried out twice.

In the next step, an attempt was made to obtain products in the shape of a cylinder by means of stereolithographic printing using the FlashForge Hunter™ printer, which was preceded by the preparation of the design with the Autodesk Fusion 360™ graphics software. The suspension was characterized by too high viscosity (it had pasty consistency), preventing even filling the gap between the bottom of the cuvette and the platform on which subsequent layers of the product were formed. This prevented obtaining composite materials using the stereolithographic printing method.

### Conclusion

As can be appreciated, the exemplary working examples provide methods usable to produce useful articles comprised of ceramic matrix composites reinforced with metallic particles. Of course variations on the methods used in the working examples may be utilized to produce useful results.

Thus the new methods of manufacturing articles comprised of ceramic matrix composites reinforced with metallic particles achieve the above stated objectives, eliminate difficulties encountered in the use of prior methods, solve problems and attain the desirable results that are described herein.

In the foregoing description certain terms have been used for brevity, clarity and understanding. However no unnecessary limitations are to be implied therefrom because such terms are used for descriptive purposes and are intended to be broadly construed. Moreover the descriptions and illustrations herein are by way of examples in the new and useful features are not limited to the exact details that have been shown and described.

Having described features, discoveries and principles of the exemplary arrangements, the manner in which they are constructed, operated and carried out, and the advantages and useful results that are attained, the new and useful methods, elements, arrangements, parts, combinations, structures, systems, equipment, operations, processes and relationships are set forth in the appended claims.

1. A method for manufacturing an article comprising ceramic matrix composites reinforced with metallic particles, comprising:
a) producing a mixture by mixing a solvent in an amount of 2-15 parts by weight with two organic monomers in an amount of 2-15 parts by weight each, and with a photoinitiator in an amount of 1-5 parts by weight based on the sum of the weights of organic monomers, wherein the photoinitiator is selected from a group comprising: a mixture of ethyl (2,4,6-trimethylbenzoyl)phenylphosphinate and bis-(2,4,6-trimethylbenzoyl)phenylphosphine oxide, bis-(2,4,6-trimethylbenzoyl)phenylphosphine oxide, and ethyl (2,4,6-trimethylbenzoyl)phenylphosphinate;
b) producing a further mixture by adding to and mixing with the mixture produced in (a) a dispersing agent in an amount of 0.2-5.0 parts by weight, a ceramic powder in an amount of 65-90 parts by weight, and a metal powder in an amount of 0.1-10.0 parts by weight wherein the dispersing agent is selected from a group comprising a polyester and polyamine copolymer as a 50% solution in a trichlorethylene-ethanol azeotrope, and a polyester and polyamine copolymer as a 50% solution in 2-butanone;
c) mixing and deaerating the further mixture produced in (b);
d) using the deaerated further mixture produced in (c) in a 3D stereolithographic printer to form a product item in accordance with a previously prepared product design;
e) sintering the product item formed in (d), whereby the article results.

2. The method according to claim 1, wherein prior to (d) the step (c) is carried out a second time.

3. The method according to claim 1, wherein in (a) the solvent comprises 2-ethylhexanol.

4. The method according to claim 1, wherein in (a) the organic monomers include triethylene glycol dimethacrylate and poly(1,3-propylene glycol) dimethacrylate.

5. The method according to claim 1, wherein in (b) the ceramic powder is selected from a group comprising: Al₂O₃, ZrO₂ and SiO₂.

6. The method according to claim 5, wherein in (b) the Al₂O₃ has a particle size in the range of 150 nm-2 μm.

7. The method according to claim 5, wherein in (b) the ZrO₂ has a particle size in the range of 40 nm-2 μm.

8. The method according to claim 5, wherein in (b) the SiO₂ has a particle size in the range of 100 nm-1.5 μm.

9. The method according to claim 1, wherein in (b) the metal powder is selected from a the group comprising: nickel and molybdenum.

10. The method according to claim 9, wherein in (b) the metallic powder has a particle size in the range of 3-15 μm.

11. The method according to claim 1, wherein in (b) the mixing is carried out in a planetary ball mill at a rotational speed of from 200 rpm to 400 rpm for from 30 to 120 minutes.

12. The method according to claim 1, wherein in (c) the deaeration is carried out in a high-speed homogenizer with a rotational speed of from 500 rpm to 2200 rpm for from 1 to 15 minutes.

13. The method according to claim 1, wherein in (d) the forming is carried out with the following printer parameters: a single layer height in the range of 0.01 mm-0.05 mm, a base printing time in the range of 10 s-60 s, an attaching time in the range of 10 s-60 s, a light intensity in the range of 50%-100 %.

14. The method according to claim 1, wherein in (e) the sintering is carried out at a temperature of 1350° C.-1650° C. in an argon-hydrogen reducing atmosphere for 1-5 h.

15. A method of manufacturing an article comprised of a ceramic matrix composite reinforced with metallic particles, comprising:
a) producing a mixture by mixing a solvent in an amount of 2-15 parts by weight with two organic monomers in an amount of 2-15 parts by weight each, and with a photoinitiator in an amount of 1-5 parts by weight based on the sum of the weights of organic monomers, wherein the photoinitiator comprises at least one of ethyl (2,4,6-trimethylbenzoyl)phenylphosphinate, bis-(2,4,6-trimethylbenzoyl)phenylphosphine oxide, and a mixture of bis-(2,4,6-trimethylbenzoyl)phenylphosphine oxide and ethyl (2,4,6-trimethylbenzoyl)phenylphosphinate;
b) producing a further mixture by adding to and mixing with the mixture produced in (a), a dispersing agent in an amount of 0.2-5.0 parts by weight, a ceramic powder in an amount of 65-90 parts by weight, and a metal powder in an amount of 0.1-10.0 parts by weight, wherein the dispersing agent comprises at least one of a polyester and polyamine copolymer as a 50% solution in a trichlorethylene-ethanol azeotrope, and a polyester and polyamine copolymer as a 50% solution in 2-butanone;
c) deaerating the further mixture produced in (b);
d) forming an item by using the deaerated mixture produced in (c) in a 3D stereolithographic printer;
e) sintering the item formed in (d), whereby the article results.

16. The method according to claim 15, wherein in (c) the further mixture is mixed and then deaerated and then again mixed and then again deaerated.

17. The method according to claim 15, wherein in (a) the solvent comprises 2-ethylhexanol.

18. The method according to claim 15, wherein in (a) the organic monomers include triethylene glycol dimethacrylate and poly(1,3-propylene glycol) dimethacrylate.

19. The method according to claim 15, wherein in (b) the ceramic powder comprises at least one of Al₂O₃, ZrO₂ and SiO₂.

20. The method according to claim 15, wherein in (b) the metal powder comprises at least one of nickel and molybdenum.
